(19) United States
(12) Patent Application Publication
(10) Pub. No.: US 2024/0377303 A1
(43) Pub. Date: Nov. 14, 2024

(54) MUON TELESCOPE AND NEUTRON DETECTOR, SYSTEM FOR MEASURING AND CHARACTERIZING LARGE VOLUMES, AND METHODS

(71) Applicant: KONKER INNOVATION LTDA., Barueri (BR)

(72) Inventors: Luis Fernando GOMEZ GONZALEZ, Campinas (BR); Erick MASCAGNI FERDINANDO, Campinas (BR); Alexandre Luiz JUNQUEIRA MARTINS, Campinas (BR)

(73) Assignee: KONKER INNOVATION LTDA., Barueri (BR)

(21) Appl. No.: 18/564,844

(22) PCT Filed: May 31, 2022
(86) PCT No.: PCT/BR2022/050185

§ 371 Date: Nov. 28, 2023

(30) Foreign Application Priority Data
May 31, 2021 (BR) 1020210106204
May 30, 2022 (BR) 1020220105731

(51) Int. Cl. G01N 9/24; G01N 9/36; G01T 1/20; G01T 3/06; G01T 3/08; G01T 7/00

(52) U.S. Cl. CPC G01N 9/24; G01N 9/36; G01T 1/2002; G01T 3/06; G01T 3/08; G01T 7/005

(57) ABSTRACT

A muon telescope and neutron detector in its constructiveness and functionalities as well as a system for measuring and characterizing large volumes comprising at least one muon telescope and further a method of auto-calibration of a muon telescope, a method of three-dimensional reconstruction of mass and/or volume using the registration of passages of passing muons, captured by a muon telescope, a method of inferring mass and/or total volume using as data the rate of muons captured by a muon telescope recorded next to or below an observed object and still a method of inferring absolute or differential density using as data the rate of muons captured by a muon telescope recorded next to or below the observed object, a neutron measurement system associated with the muon telescope, allowing the detection of the integral and/or directional flow of atmospheric neutrons and a method for inferring the amount of water/humidity or hydrocarbons in the studied volume from the neutron flow data.

### FIELD OF APPLICATION

The present invention is contained in the technical field of volume and density measuring equipment, more precisely in the field of large volume and density measuring equipment.

The present invention shows a muon telescope and neutron sensor developed and adapted for use in a measurement system for large volumes with application in areas of mining, soil analysis, storage of large volumes or even prospecting for materials with no need for physical collection of samples. Said invention also shows methods of self-calibration and three-dimensional reconstruction of mass and/or volume.

### DESCRIPTION OF THE PRIOR ART

One of the greatest difficulties in the technical field of equipment for measuring large volumes and densities, with large volumes being those that exceed tens of thousands of tons, is the accuracy and reliability as well as the execution of the data acquisition procedure.

Currently, the methods used to measure large volumes involve the use of an orthophotography measurement technique, or the combination of more than one technique from the already known manual or automated topographic measurements by using drones to capture images and with its subsequent processing, and measurement by mechanical scales when feeding or removing materials from the measured volumes.

In turn, the techniques used to measure the density of large volumes of masses involve the use of densimeter sensors and/or numerical models inferred from sensor readings. Regarding the methods used to measure humidity, aiming to mischaracterization of dams for example, they generally use small samples collected in the field, taken to the laboratory where they are measured in specific hydrometers for each type of material. Finally, for the constant concern of liquefaction and regressive tubular erosion, piping, of dams, there is no direct sensing method; however, the technique using piezometers at some specific points of the dam is used as an indirect measurement method.

Each of the current measurement methods have relevant operational limitations that directly affect the precision or even the application of the said methods, compromising the acquisition of information, highlighting the need for a human operator present at the measurement location, the impossibility of carrying out measurement due to unfavorable meteorological conditions such as rain, dust clouds, lack of natural lighting, mechanical wear and constant need for corrective and predictive maintenance plans, the impossibility of a complete view of the measured volume, dependence on the use of a mathematical model, and finally the impossibility of identifying the content immediately below the external surface of the measured volume.

Therefore, the applications of known methods imply important limitations in the solutions available for this type of measurement. Methods that have real-time measurements, such as measurement using mechanical scales, have significant systematic errors, which accumulate over time. This accumulation of errors becomes relevant, with values exceeding 8% in some cases, thus requiring calibrations in short periods of time.

In turn, absolute methods such as topographic measurement, or orthophoto measurement, have more controlled systematic errors, but cannot be used continuously, so they only allow periodic, biweekly or monthly measurements due to the costs inherent to their applicability. Therefore, the methods with the best systematic error rate have insufficient statistical significance for the management of these variables having intrinsically large variations at periods of time of hours or days, as occurs in the monitoring of ore piles.

The presented limitations showed that there is currently no single method with an error (in accuracy) better than 5% with the capacity to measure large volumes that vary in mass every few hours or days. Therefore, an attempt to improve the reliability and accuracy of large volume measurements is to combine the measurement methods showed with the aim of reducing statistical and systematic errors.

The combination of the methods showed herein, however, is notable for its cost higher than applying one of the methods in isolation fashion, and also for two other important limitations, namely the need to operate with a group of people with different skills and the impossibility of inferring data regarding the material below the external surface of the monitored volume.

Some patent documents are notable for trying to solve some of the problems listed, such as document WO2021038129, under the title “System and Method for Material Density Distribution Survey on Cosmic Muon Detection”. In its abstract, said document describes a system and method designed to measure and record in three-dimensional space an attenuation of the flux of muon particles induced by cosmic rays through a material. The attenuation of said muons determines density variations in said material in terms of density, depth, shape and size. Muon data can be combined with several other types of data. Passing muons are detected and recorded by one or several muon detection devices designed to be robust and shock resistant. If necessary, each individual muon detection device can be controlled remotely or automatically. The muon detection system can be powered by an energy storage device that can be recharged using renewable energy, aggregate or electrical grid. The invention comprises method steps that allow the characterization of material density in various dimensions, including those over time.

Another document that attempts to solve part of the problems showed by the prior art is document JP2010101892 intitled “Internal Structural Analyzer of Huge Object”. In its abstract, the said document describes an observation device capable of viewing and analyzing the internal structure of a huge object such as a volcano in real time from a remote location. This object measuring device includes a pair of muon sensor modules on which a plurality of muon sensors for detecting cosmic rays passing through the huge object are respectively mounted, a muon reading module for receiving and processing output signals of each muon sensor and a housing for storing the muon sensor modules and the muon readout module. The muon reading module has a substrate; a substrate-mounted muon readout processing circuit connected to each muon sensor module to process a detection signal from each muon sensor, generating an angle distribution histogram and accumulating it in a memory; and an interface.

There is also document RU2008140853 intitled “Method and Device for Obtaining Muonography”. In its abstract, said document describes cosmic ray muons captured simultaneously from all directions of the celestial hemisphere, first during a preparation phase and then during an exposure phase. The angle of arrival at the facility is calculated for each muon. The angular range containing the obtained arrival angle values is found. The number of muons in the found range per unit is increased, thus filling the background and multi-muon exposure matrix. Furthermore, the filled matrix is used to calculate a matrix of relative variations of muons in different directions, which is then converted into an image representing muonography. In the device, the number, dimensions and relative position of detection elements in coordinate planes are selected based on requirements that increase the angular accuracy of the reconstruction of a muon track and the number of possible reconstructed directions, and the system for experimental information processing can calculate real-time arrival angles at each muon facility.

Even though the three said documents contribute to reducing the prior-art problems, they are unable to present a definitive solution that allows the continuous use of the equipment, since they do not show auto-calibration, as well as an affordable cost to use, given that current methods have excessively high costs or an acceptable systematic error rate.

Therefore, the prior art would benefit from the advent of a solution providing an economically efficient way of carrying out volume and density measurements in a consistent manner and with low systematic and statistical error and that enables an evolutionary platform to carry out measurements internal to the volumes of interest, without the need for physical intervention, being carried out through the use of passing radiation on the measured body, also allowing continuous measurements to be carried out with no human intervention, with an error equal to or less than 5%.

### OBJECTIVES OF THE INVENTION

An objective of the present invention is to present a muon telescope-type equipment for application in measuring large volumes and the density of large volumes.

Another objective of the present invention is to disclose a neutron measurement system associated with the muon telescope, allowing it to detect the integral and/or directional flow of atmospheric neutrons to infer the amount of water/humidity or hydrocarbons in the studied volume.

It is also an objective of the present invention to disclose a system formed by a muon telescope as part of a measurement and data acquisition module and which also comprises a concentration and transfer module, an analysis and transformation module and a module presentation.

A further objective of the present invention is to disclose and describe an auto-calibration muon telescope method, which in turn allows said telescope to work continuously, with no need for human intervention.

Another objective of the present invention is to disclose and describe a method for three-dimensional reconstruction of mass and/or volume, using data relating to the passage of muons through the mass and/or volume.

Finally, one of the objectives of the present invention is to disclose and describe a method for inferring absolute or differential density using as data the muons rate recorded next to or below the studied object.

### BRIEF DESCRIPTION OF THE INVENTION

The present invention achieves the objectives showed based on a system configuration working in a continuous and integrated manner, allowing systematic measurements of the measured volume to be carried out with increased precision over time and with quick availability of information, aiming to feed production operational management processes or industrial systems that depend on this information.

This type of action is possible through the detection of the muons flow, that is, secondary particles generated naturally at the top of the Earth's atmosphere due to the interaction of a primary cosmic ray, which propagate towards the Earth's surface, passing through the matter that is on their way until they decay into a first-generation lepton (electron or positron).

The equipment also makes it possible to detect the integral or directional flow of atmospheric neutrons, particles that have creation features similar to muons, since they are also byproducts of primary cosmic rays, however, they have unique features of interaction with matter, such as the absence of electrical charge, approximately nine times the rest mass of a muon, and interaction with matter mediated by the strong force.

The detection of two different particles in the telescope makes it possible to infer, in addition to the measured volume, some characteristics of the material, such as the hydrogen concentration used to infer the humidity or water concentration, of the matter passed through. This attribute is particularly important in the characterization of structures such as dams.

The achievement of the present invention in its objectives is possible, since depending on the type of matter passed through by the muons, there is a known attenuation in the measured flux, which can be used in reverse to infer which material and/or its dimension.

Since this flow occurs constantly, especially varying in relation to solar cycles and atmospheric pressure, in all directions from the celestial vault, with a known angular distribution, it is possible for a muon telescope to measure this attenuation and consequently infer relevant information about the matter below it.

The present invention is carried out using a muon telescope built with the ability to infer the individual arrival direction of each muon, making possible an operation similar to that of a computerized tomography used in medicine, but for measuring bodies on a much larger scale, with the advantage of having a natural, sustainable, free radiation source available anywhere on the planet.

In the present invention, the collected data is processed using both analytical and machine learning algorithms (artificial intelligence), generating measurement information with accuracy greater than current processes, continuously and which can be used for systemic integration or feeding process of operational decision-making in a more assertive way than current methods.

In carrying out the present invention, the muon telescope is constructed in such a way as to be auto-calibrated and continuously, not requiring human intervention either for its operational functioning or for calibration.

### BRIEF DESCRIPTION OF THE DRAWINGS

The subject matter of this Invention will be completely clear in its technical aspects from the detailed description that will be made based on the figures listed below, wherein:

FIG. 1 shows a schematic model of the components of the present invention from the measurement and data acquisition module to its presentation and systemic integration module;

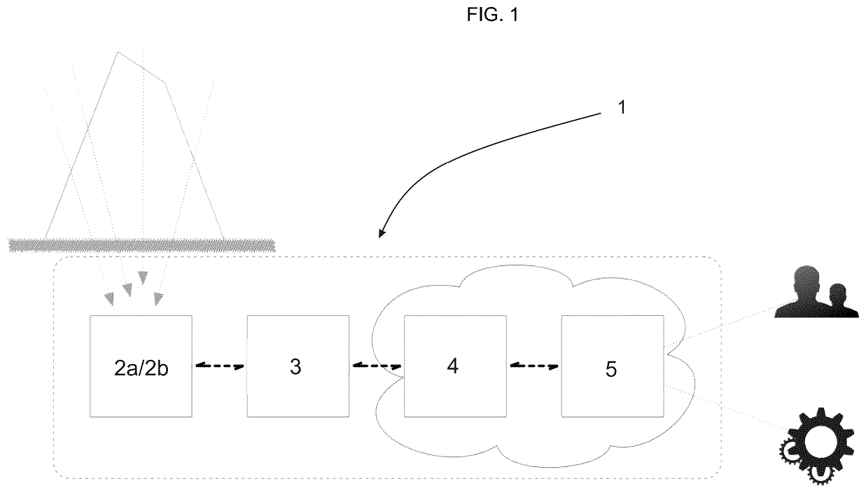

FIG. 2 shows a positioning diagram of the measurement and data acquisition module in relation to the volume to be measured;

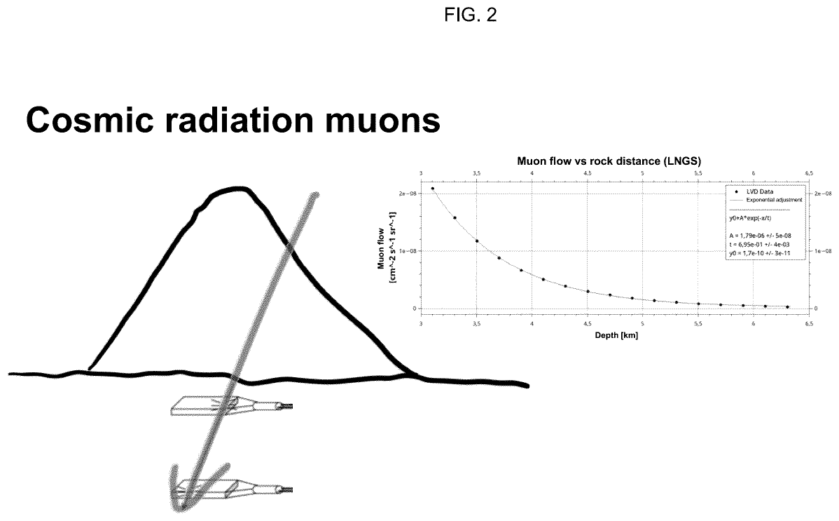

FIG. 3 shows a muon telescope built with multiple measurement planes;

FIG. 4 shows the schematic of a muon particle flow measurement plan;

FIG. 5 shows details of the quick fitting, with stable mechanical positioning between the scintillator bar and the A/D measurement and acquisition board;

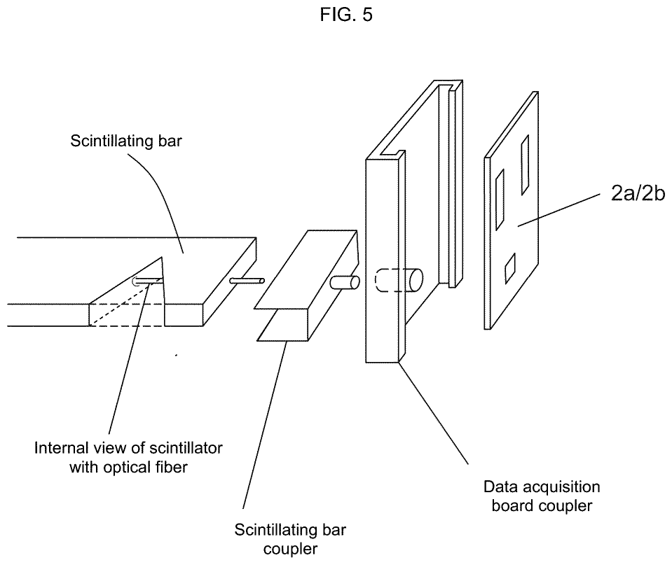

FIG. 6 shows a 3D detail of the fitting structures and mechanical positioning of the A/D measurement and data acquisition boards;

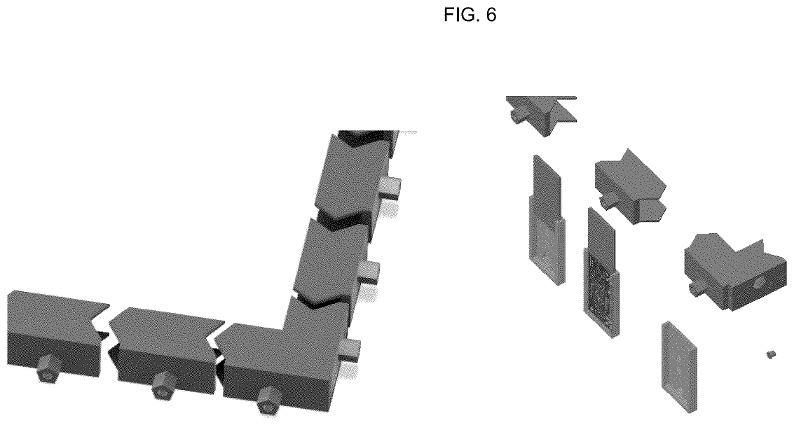

FIG. 7 shows details of the A/D measurement and acquisition boards (analog and digital) used in the detection plans;

FIG. 8 shows a gateway for the system's analysis and transmission module and details of the second processing level;

FIG. 9 shows an example of a control dashboard for the presentation and systemic integration module;

FIG. 10 shows a photograph referring to the special boards of the data acquisition module;

FIG. 11 shows a neutron-sensitive semiconductor element and the representative scheme of the directional neutron detection planes; and

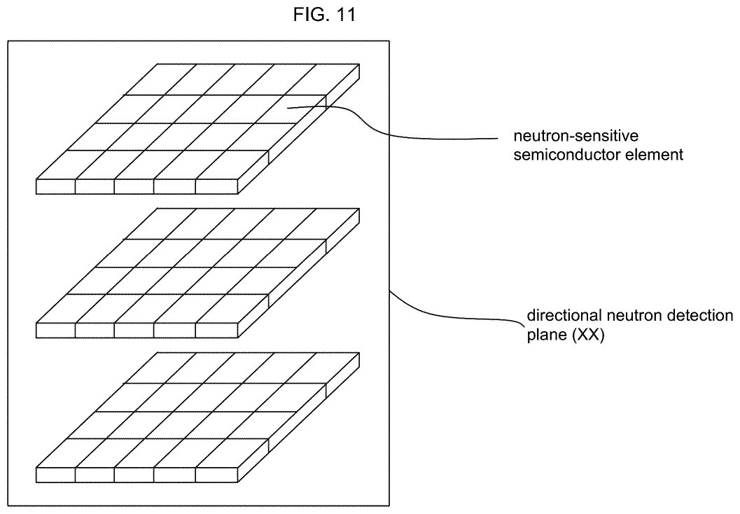

FIG. 12 shows the representative scheme of the integral neutron detector comprising scintillator bars and the neutron dopant.

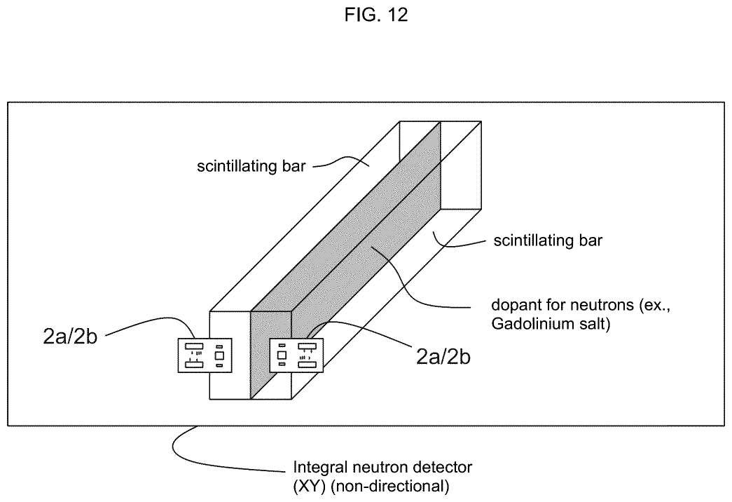

### DETAILED DESCRIPTION OF THE INVENTION

In accordance with the objectives showed in the Objectives of the Invention and Brief Description of the Invention fields, the present application for “MUON TELESCOPE AND NEUTRON DETECTOR, SYSTEM FOR MEASUREMENT AND CHARACTERIZATION OF LARGE VOLUMES AND METHODS” presents a muon telescope (21) in its constructiveness and functionalities as well as a system (1) for measuring large volumes comprising at least one muon telescope and also a method for auto-calibrating muon telescopes (21), a method for three-dimensional mass rebuilt and/or volume using the recording of passages of passing muons captured by muon telescopes, a method of inferring mass and/or total volume using as data the rate of muons captured by muon telescopes (21) recorded alongside or below of an observed object and also a method of inferring absolute or differential density using as data the rate of muons captured by a muon telescope (21) recorded next to or below the observed object. It also presents a neutron measurement system which, when associated with the muon telescope (21), allows the inference of the concentration of water/moisture or hydrocarbons in the studied volume.

The system (1) for measuring large volumes comprises up to five main modules: two measurement and data acquisition modules (2a and 2b), concentration and transfer module (3), analysis and transformation module (4), and a presentation and systemic integration module (5).

The measurement and data acquisition modules (2a and 2b) can work together, with the data acquisition module (2a) intended for detecting the muon flow and the data acquisition module (2b) intended for detection of the neutron flow, this being optional.

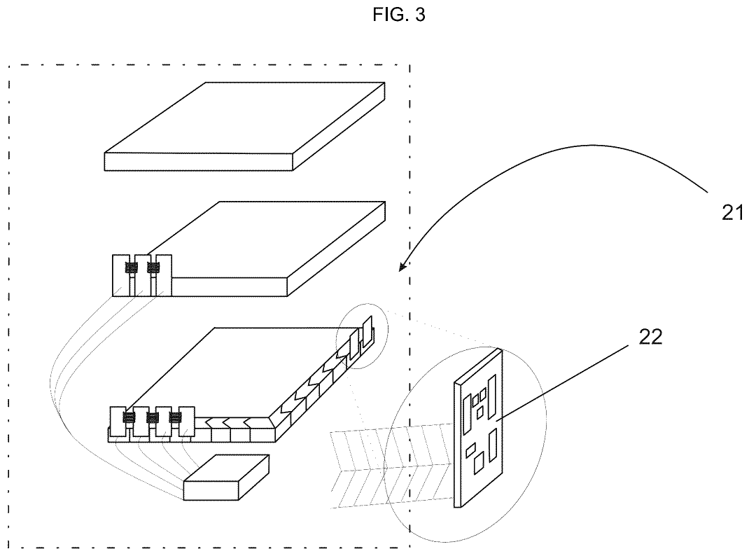

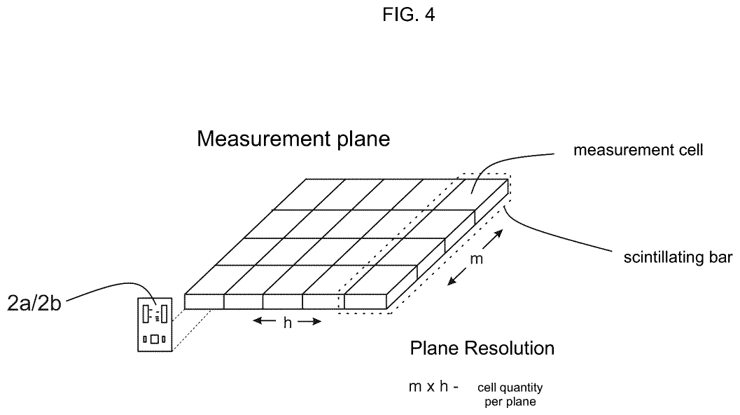

The measurement and data acquisition module (2a) uses a muon telescope (21), which is responsible for measuring the muon flow and the direction of each muon, within the experimental limits of the measurements. Said muon telescope (21) is designed preferably for the use of solid-state components, and it has miniaturized dimensions, as can be seen in FIG. 3 and also multiple measurement planes, as can be seen in FIG. 4.

The multiple measurement planes present in the muon telescope (21) are responsible for detecting the flow of charged particles as well as digitizing the analog information that was collected during the measurement, and such information will be processed and analyzed by the system (1).

Each measuring plane of the muon telescope (21) comprises a N number of scintillating bars arranged in two orthogonal directions named X and Y. Each intersection between the N bars arranged in the X direction and the N bars arranged in the Y direction generates an area sensitive cell call.

The scintillating bars present in each measuring plane of the muon telescope (21) are elements that emit light with each passage of charged particles. The light generated by said scintillating bars is captured using fiber optic cables and then transmitted to an optical detector.

Each muon telescope (21) contains at least three measurement planes, with the distances between them depending on the opening required for the muon telescope (21) to observe the volume to be studied in its entirety and the precision required for the central region of the same volume. The distance between the two measurement planes closest to each other, in the direction of the Z axis (height) is responsible for delimiting the detector's maximum opening, and this maximum opening has an upper limit of approximately 2 Pi steradian (2.π sr).

In turn, in the muon telescope (21), the distance between the upper plane and the lower plane, in the direction of the Z axis, is responsible for delimiting the minimum opening of the detector and consequently the maximum spatial resolution obtained in the central region of the volume studied, and the spatial resolution uses one cell from each of at least three measurement planes.

The use of at least three measurement planes, in addition to enabling the use of multiple openings and multiple resolutions also makes it possible to calculate the measurement efficiency of the central plane directly, using the telescope double and triple coincidences.

From the calibration data of the central planes and the simulation data it is possible to calculate the efficiency of the peripheral planes, thus enabling the automatic calibration of the muon telescope (21), using only the double and triple coincidences of the system (1).

This central plane calibration system consists of calculating the flow observed by three bars in the same vertical plane and the same flow observed by the most extreme bars above and below the central bar. Since the measurement probabilities are independent, a system with maximum efficiency, i.e. 100%, would have the same double and triple counts. Therefore, the measurement efficiency is calculated from the difference between the triple and double coincidences as a function of the double coincidences.

On the other hand, the extreme planes require geometric simulation to calculate the perfect rate of relationship between triple and double coincidences, and this efficiency calculation takes place through the difference between the number obtained through simulation and the measured number.

The use of these methods results in greater robustness of the muon telescope (21) since the number of drives for local physical maintenance is reduced, especially in places where access to them is more difficult, such as in mining environments.

The light system of the muon telescope (21) is formed by a sensor with sensitive detection capacity even in the presence of a few photons, in this case, preferably using a solid-state sensor (silicon) of the “Silicon Photomultipliers” type (SiPM), with statistical capacity to detect one photon at a time.

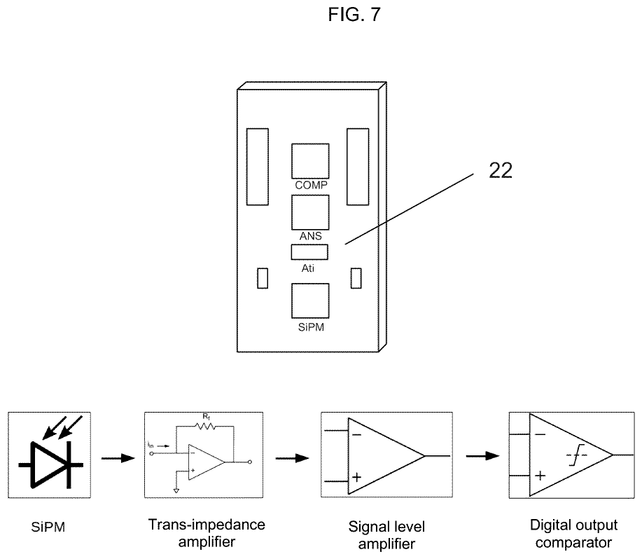

In the light detection system of the muon telescope (21), the SiPM sensor is inserted into a board (22) specifically designed for data acquisition from said muon telescope (21), having a board for each light sensor, as shown in FIG. 7.

The boards (22) are designed aiming to contain all the components required for converting light into an electrical signal, amplification, generation of threshold voltage for the comparator and generation of the trigger signal. Based on this special constructiveness, the boards (22) are responsible for generating the system zero-level trigger, which is generated every time a signal exceeds the discrimination amplitude, that is, the voltage used at the comparator input.

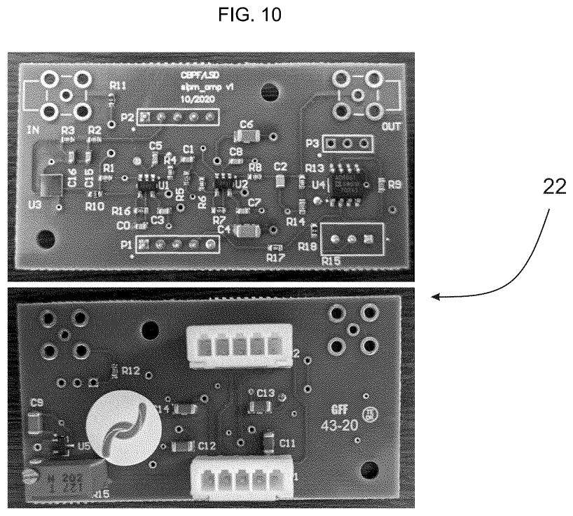

The boards (22) are built comprising components such as SiPM, responsible for converting light into electrical signals; operational amplifiers, responsible for electronic coupling and amplification of the SiPM signal; comparator, responsible for generating the digital signal; and reference voltage, responsible for generating the voltage level used by the comparator, as can be seen in FIG. 10.

Regarding the operation of the light detection system, once the light signal is converted to an electrical signal through the SiPM sensor, it is amplified and then directed to the zero-level trigger system, in which a signal with a greater amplitude that a given threshold is converted to a digital signal by a comparator.

In the light detection system, the choice of the threshold data is made based on laboratory studies previously carried out with the system, and it can be adjusted, if necessary, on the board (22) specifically designed for data acquisition. This adjustment can be done either manually, with a variable resistor, or automatically (or even remotely) using a voltage control circuit for this threshold (Digital to Analog Converter) or a programmable resistor.

This type of design for the system (1) presents several advantages compared to the state of the art, since it allows the use of a modular board that can be easily mechanically integrated with the scintillating bars, allowing for simplified assembly and replacement of components, through a physical quick-fitting mechanism providing individual manipulation of each of said boards (22), ensuring their adequate positioning inside the muon telescope (21).

Another advantage inherent to the system configuration (1) is that the physical location of the entire measurement and data acquisition module (2a), with light sensor and amplifiers, together with the zero-level trigger, on the same electronic board, makes it possible not to only the reduction in the device size, the volume of cables used and consequently its weight, as well as the reduction in the energy consumption of the equipment and a better signal-to-noise ratio (SNR), which also makes it possible to use it in environments more restricted.

The level 1 trigger system is where the selection of signals that have muon characteristics occurs. As scintillating bars are sensitive to any type of charged particle, it is necessary to implement a logic of coincidence between the planes, in order to record only signals that occur in more than one plane, within a time window of tens of nanoseconds.

The implementation of the coincidence logic of the level 1 trigger system is necessary in order to preclude local radiation events in the system (1), such as electrons that cross only one of the boards (22).

It is also the function of the level 1 trigger system does not accept events generating ambiguous signals recorded in more than one cell per plane. The level 1 trigger also functions to record double and triple coincidences between planes, which, in turn, enables the continuous auto-calibration of the muon telescope (21).

Once an event is accepted by the level 1 trigger system, the particle's passing position in each plane and the absolute measurement time are recorded in a memory that can be read by a computer system, and this data can be concentrated and transferred to more complex systems.

The system (1) also comprises a measurement and data acquisition module (2b), which consists of a neutron detection structure that can measure the integral flow through integral detectors (24) or directional flow through of directional neutron detectors (23), depending on the measurement need. Integral neutron detectors (24) use data acquisition electronics based on the detection of thermal neutrons in a bar of material coated with Gadolinium (Gd) or a container with liquid containing Gadolinium salt in solution.

Neutron detection, in turn, occurs using plastic scintillating bars to detect gamma rays, the sum energy of which is 8MeV, from Gadolinium de-excitation. The capture of light and its transformation into an electronic signal occurs in the same way as in the measurement and data acquisition module (2a) present in the muon telescope (21). In this case, detection occurs only with low-energy neutrons, that is, thermal, causing it to lose its directionality signature, allowing only a full detection of the neutron rate.

Directional neutron detection is based on direct reading of the state change rate (bit flip) in a semiconductor system (FPGA, ASIC, CMOS, RAM) using detection planes with sensors, preferably, in the state-solid state; however, any solid-state electronics that have semiconductor cells with one or more bits as elements can also be used as sensors.

In the measurement and data acquisition module (2b), the detection planes are composed of one or more sensitive elements, status of which is constantly read by the trigger system, and both types of neutron detectors (23 and 24) require muon telescope data (21). The reading of multiple simultaneous changes of state in semiconductor cells triggers a trigger signal, as long as it is not temporally correlated with the muon passage measured by the muon telescope (21), otherwise it would generate a false positive in the neutron detection. Reading the neutron passage positions allows us to infer the direction of arrival of this particle.

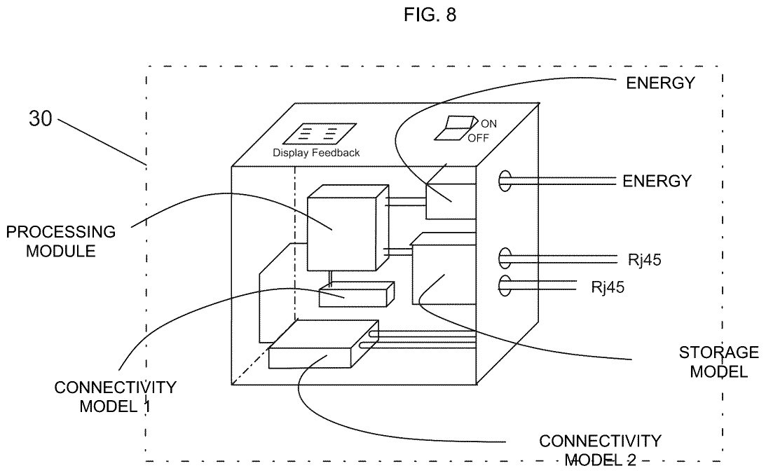

The system (1) also comprises a concentration and transfer module (3) comprising a gateway (30) as shown in FIG. 8. The gateway (30) aims to guarantee communication with the muon telescope (21) and consequently the regularly obtaining data, recording this data in a reliable temporary memory, pre-processing the information and sending this data to the analysis and transformation module (4), said analysis and transformation module (4) can work locally, remotely or in a cloud structure.

Communication between the muon telescope (21) and the gateway (30) can occur in different ways and means, including an ethernet network, optical fiber, Wi-Fi network or even other types of radio frequency or cable communication. In turn, communication between the gateway (30) and the analysis and transformation module (4) can occur following the same network mechanisms possible for communication between the gateway (30) and the muon telescope (21), as well as by any other type of communication with the internet, such as cell phone networks and satellite networks.

Since the gateway (30) has all the data generated by the muon telescope (21) and the measurement and data acquisition module (2b) of the neutron detector (23, 24), it can process the full-flow data using a mathematical model, such as Y=a.\hat{ }b, wherein Y corresponds to the mass of material, x corresponds to the muon flow and the variables a and b are determined by calibration at the location of the pile.

The use of the mathematical model aims to quickly, although approximate, generate the material mass observed by the telescope. This pre-analysis, as it is computationally simple, can be generated directly in the gateway (30), and there is the possibility that the gateway (30) and the analysis and transformation module (4) are the same device, if necessary, in a given environment.

The analysis and transformation module (4), in turn, is responsible for the three-dimensional reconstruction of the volume observed by the muon telescope (21) and for calculating the composition of hydrogen-rich materials, using concentrated data from both measurement and data acquisition modules (2a and 2b), if available, and transported by the gateway (30). To this end, the analysis and transformation module (4) uses a combination of two methods, namely the analytical geometry technique and the machine learning method (artificial intelligence).

The analytical geometry technique is used to represent the projection of each cell of the muon telescope (21) on the upper half-sphere and, through the known angular distribution of the muons, calculate the missing rate for each region. The analytical geometry technique is also used to calculate the amount of material crossed through the use of a mathematical attenuation model and thus enable the 3D reconstruction of the shape of the observed object.

Likewise, if there are integral or directional neutron data, it will be possible to infer the amount of hydrogen, such as water or hydrocarbons, crossed in the path of this secondary cosmic ray based on the measured attenuation. If directional data is available, 3D reconstruction of the measurement projection will also be possible. Since there are only integral data, the result of the concentration of hydrogen-rich materials, such as water or hydrocarbons, is obtained through an analytical calculation with calibration parameters obtained in the laboratory.

The machine learning method, in turn, uses a neural network trained using computer simulation data of the attenuation caused by muons and neutrons, if available, in observed volumes of different shapes and different geometries.

The final result presented by the analysis and transformation module (4) is a volume, mass or density, depending on the type of calibration used, whose dimensions are anchored by the analytical geometry technique and refined by the machine learning model. This refinement makes it possible to obtain data regarding the internal structure of the studied object, such as low-density regions, for example, caves inside mountains. This process takes place periodically and uninterruptedly, generating information on a temporal scale also stored in the analysis and transformation module (4), whether installed on a machine, equipment or on a platform available in a cloud environment.

In an assembly variation of the system (1), it is possible to use data from multiple lines of sight, that is, multiple muon telescopes (21). This variation aims to reconstruct the three-dimensional characteristics of the studied environment or object with greater precision and greater independence from machine learning methods. This type of option is especially relevant in scenarios where there are very large and random changes in the environment or object, which makes refinement using machine learning with simulation data much more complex or even impossible.

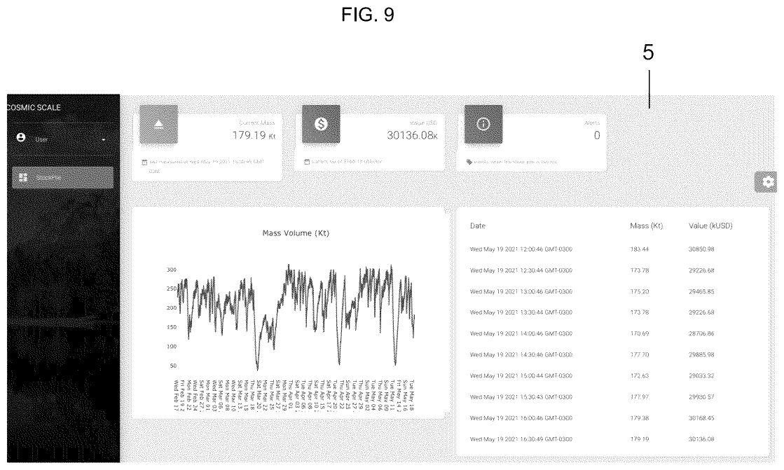

Finally, the system (1) also comprises a presentation and systemic integration module (5) responsible for using the automatically generated temporal data for visual presentation through control dashboards, as shown in FIG. 9, and also for feeding programming interfaces (API) for systemic integration of data in production environments.

Regarding the use of the system (1), it is important to highlight that the muon telescope (21) and the integral neutron detectors (24) can be physically allocated under the volume to be measured and/or studied. It can also be allocated laterally in reference to said volume, when it comes to flow measuring of muons and/or neutrons with a solid-state detection system. The equipment can remain installed continuously.

It is to be understood that the present description does not limit the application to the details described herein and that the invention is capable of other embodiments and of being practiced or carried out in a variety of ways, within the scope of the claims. Although specific terms have been used, such terms should be construed in a generic and descriptive sense and not for the purpose of limitation.

1. A muon telescope for measuring the flow and direction of each muon, characterized in that it is designed for the use of components, preferably in solid state, having multiple measurement planes and such multiple measurement planes are responsible by detecting the flow of charged particles, wherein each measurement plane of the muon telescope comprises a number N of scintillating bars arranged in two orthogonal directions named X and Y, and each intersection between the m bars arranged in the X direction and the h bars arranged in the Y direction generates a sensitive area named a cell.

2. The muon telescope, according to claim 1, wherein the scintillating bars present in each plane of measurement of the muon telescope are elements emitting light at each passage of charged particles, and the light generated by the scintillating bars is captured through fiber optic cables and then transmitted to an optical detector.

3. The muon telescope, according to claim 1, wherein the muon telescope comprises:
at least three measurement planes, with the distances between them depending on the opening required for the muon telescope to observe the volume to be studied in its entirety and the necessary precision for the central region of the same volume; and
a light detection system formed by at least one board built with components such as silicon photomultiplier (SiPM) responsible for converting light into electrical signals; operational amplifiers responsible for the electronic coupling and amplification of the SiPM signal; comparator responsible for generating the digital signal, and reference voltage responsible for generating the voltage level used by the comparator.

4. The muon telescope, according to claim 3, wherein in the light detection system, the light signal is converted to an electrical signal by the SiPM sensor, it is amplified and then directed to the zero-level trigger system, wherein a signal with amplitude greater than a said threshold is converted to a digital signal by a comparator.

5. A system for measuring and characterizing large volumes comprising at least one muon telescope according to claim 1, wherein the system comprises four main modules, one measurement and data acquisition module, concentration and transfer module, analysis and transformation module and a systemic presentation and integration module, wherein the measurement and data acquisition module comprises a muon telescope, the system may contain a measurement and data acquisition module, wherein said measurement and data acquisition module consists of a structure of neutron detection that can measure the integral or directional flow of neutrons, depending on the measurement need.

6. The system, according to claim 5, wherein the system comprises a zero-level trigger system located in the measurement and data acquisition module sending data to the level-1 trigger system located in the concentration and transfer module, where the selection of signals having muon characteristics occurs, where the level-1 trigger system does not accept events generating ambiguous signals, recorded in more than one cell per plane.

7. The system, according to claim 5, wherein the system comprises a logic of coincidence between the planes, located in the concentration and transfer module responsible for recording only signals occurring in more of a plane, within a time window of tens of nanoseconds, wherein the coincidence logic system of the level-1 trigger system is responsible for precluding local radiation events in the system.

8. The system, according to claim 5, wherein the concentration and transfer module comprises the level-1 trigger system and the gateway responsible for ensuring communication with the muon telescope, being responsible for regularly obtaining data, recording these data in a reliable temporary memory, pre-processing the information and sending these data to the analysis and transformation module, said analysis and transformation module can work locally, remotely or in a cloud structure.

9. The system, according to claim 8, wherein the communication between the muon telescope and the gateway and the communication between the analysis and transformation module and the gateway occur through an option from optical fiber, Wi-Fi network, other types of radiofrequency or cable communication, cell phone or satellite networks.

10. The system, according to claim 9, wherein the gateway can process the total flow data using a mathematical model and that the gateway and the analysis and transformation module can be the same device.

11. The system, according to claim 5, wherein the analysis and transformation module is responsible for the three-dimensional reconstruction of the volume observed by the muon telescope through the data concentrated and transported by the gateway, using the combination of the analytical geometry technique and the machine learning method, wherein the analytical geometry technique is used to represent the projection of each cell of the muon telescope in the upper half-sphere and through the angular distribution known of the muons, calculate the missing rate for each region and to calculate the amount of material traversed through the use of a mathematical model of attenuation and thus enable the 3D reconstruction of the shape of the observed object while the machine learning method uses a neural network trained using computer simulation data of the attenuation caused by muons in observed volumes of different shapes and different geometries.

12. The system, according to claim 5, wherein the presentation and systemic integration module is responsible for using the automatically generated temporal data for visual presentation through control dashboards and to feed programming interfaces for systemic integration of data in productive environments, with data coming from one or more lines of sight.

13. An auto-calibration method of a muon telescope, the muon telescope according to claim 1, wherein the auto-calibration occurs through the calibration of the central planes and the calibration of the peripheral planes, wherein:
the calibration of the central planes consists of calculating the flow observed by three bars in the same vertical plane and the same flow observed by the most extreme bars, above and below the central bar, and then the maximum efficiency is calculated through the difference between triple and double coincidences as a function of double coincidences;
the calibration of the extreme planes requires geometric simulation to calculate the perfect rate of relationship between triple and double coincidences, and this efficiency calculation is done through the difference between the number obtained through the simulation and the measured one;
wherein the trigger system records double and triple coincidences between planes, not accepting events that generate ambiguous signals recorded in more than one cell per plane;
and once the event is accepted by the trigger system, the particle passing position in each plane and the absolute measurement time are recorded in a memory that can be read by a computer system, and this data can be concentrated and transferred to more complex systems.

14. A method of three-dimensional reconstruction of mass and/or volume by a system, the system according to claim 5, comprising a muon telescope for measuring the flow and direction of each muon, wherein it is designed for the use of components, preferably in solid state, having multiple measurement planes and such multiple measurement planes are responsible by detecting the flow of charged particles, wherein each measurement plane of the muon telescope comprises a number N of scintillating bars arranged in two orthogonal directions named X and Y, and each intersection between the m bars arranged in the X direction and the h bars arranged in Y direction generates a sensitive area named a cell, wherein the three-dimensional reconstruction method has the following steps:
(i) data measured by one or more muon telescopes from the light signal data are converted into an electrical signal by a SiPM sensor, amplified and then directed to the zero-level trigger system, wherein a signal with amplitude greater than a said threshold is converted to a digital signal by a comparator;
(ii) the signal from the zero-level trigger system is sent to the level-1 trigger system, wherein signals with muon characteristics are selected, not accepting events generating ambiguous signals, recorded in more than one cell per plane, recording the double and triple coincidences between planes, by means of a coincidence logic, wherein for the events accepted by the level-1 trigger, the particle passing position in each plane and the absolute measurement time are recorded in a memory that can be read by a computer system or concentrated and transferred to a more complex system;
(iii) the accepted events then pass to the concentration and transfer module comprising a gateway which communicates directly with the muon telescope and regularly obtains the measurement data, records the data in a reliable temporary memory, processes the information in a preliminary way and sends the data to the analysis and transformation module by communication through network mechanisms or any type of communication with the internet;
(iv) in the analysis and transformation module the data are submitted to the techniques of: analytical geometry and the machine learning method, wherein the analytical geometry technique represents the projection of each cell of the muon telescope in the upper half-sphere and through the known angular distribution of muons, it calculates the missing rate for each region, as well as it calculates the amount of material crossed through the use of a mathematical attenuation model while the machine learning method is used a neural network trained using computer simulation data of the attenuation caused by muons in observed volumes of different shapes and different geometries, resulting thus in a 3D reconstruction of a volume, mass and or density; and
(v) temporal data generated are used automatically by the presentation and systemic integration module for visual presentation through control dashboards and to feed programming interfaces for systemic integration of data in productive environments.

15. A method for humidity inference of a sample using a system according to claim 5, comprising a muon telescope for measuring the flow and direction of each muon, wherein it is designed for the use of components, preferably in solid state, having multiple measurement planes and such multiple measurement planes are responsible by detecting the flow of charged particles, wherein each measurement plane of the muon telescope comprises a number N of scintillating bars arranged in two orthogonal directions named X and Y, and each intersection between the m bars arranged in the X direction and the h bars arranged in the Y direction generates a sensitive are named a cell, wherein it comprises the following steps:
(i) data measured by one or more directional or integral neutron detectors, the directional detectors being based on the direct reading of the state change rate (bit flip) in a semiconductor system (FPGA, ASIC, CMOS, RAM) and the integral detectors use electronic data acquisition from the detection of thermal neutrons through a bar of material coated with Gadolinium or container with liquid containing Gadolinium salt in solution, where plastic scintillating bars detect the gamma rays of Gadolinium de-excitation, generating light signals that are converted into an electrical signal by means of a SiPM sensor, amplified and then directed to the trigger system wherein both types of neutron detectors require data from the muon telescope because they have as a trigger criterion the non-temporal correlation of the signal with the passage of a muon;
(ii) the signals then pass to the concentration and transfer module comprising a gateway and the level-1 trigger system which communicates directly with the measurement and data acquisition module, records the data in a reliable temporary memory, processes the information in a preliminary way and sends the data to the analysis and transformation module by communication through network mechanisms or any type of communication with the internet;
(iii) in the analysis and transformation module, the directional data, if any, are subjected to analytical geometry techniques and the machine learning method, where the analytical geometry technique represents the projection of each neutron signal, calculating the composition of hydrogen-rich materials and from the readings of the positions of passages of each neutron and inferring the direction of arrival of this particle, where, if there are only integral data, the result of the concentration of hydrogen-rich materials, such as water or hydrocarbons, is obtained through an analytical calculation with calibration parameters obtained in the laboratory.
